(19) United States
(12) Patent Application Publication
(10) Pub. No.: US 2020/0137948 A1
(43) Pub. Date: May 7, 2020

(54) MATERIAL DETECTING MECHANISM OF SOWING MACHINE, SOWING MACHINE, AND UNMANNED AERIAL VEHICLE FOR PROTECTING PLANTS

(71) Applicant: SZ DJI TECHNOLOGY CO., LTD., Shenzhen (CN)

(72) Inventors: Xidi HUANG, Shenzhen (CN); Chi ZHANG, Shenzhen (CN)

(21) Appl. No.: 16/738,220

(22) Filed: Jan. 9, 2020

Related U.S. Application Data
(63) Continuation of application No. PCT/CN2017/109272, filed on Nov. 3, 2017.

(30) Foreign Application Priority Data
Oct. 31, 2017 (CN) PCT/CN2017/108729

(51) Int. Cl. A01C 7/10; G01F 23/284

(52) U.S. Cl. CPC A01C 7/105; B64D 1/02; G01F 23/284

(57) ABSTRACT

A sowing machine includes a stirring mechanism and a material detecting mechanism. The material detecting mechanism includes a driven member, a magnetic member, and a Hall effect sensor. When not blocked by material in the sowing machine, the driven member is configured to rotate under a driving force of a rotating shaft of the stirring mechanism, and drive the magnetic member to rotate; and the Hall effect sensor is configured to detect a first signal corresponding to the magnetic member indicating material absence. When blocked by the material, the driven member is configured to stop rotating under a resistance of the material, and stop driving the magnetic member to rotate; and the Hall effect sensor is configured to detect a second signal corresponding to the magnetic member indicating material presence. Whether the material exists is determined based on the first or the second signal.

### CROSS-REFERENCE TO RELATED APPLICATIONS

This application is a continuation of International Application No. PCT/CN2017/109272, filed Nov. 3, 2017, which claims priority to International Application No. PCT/CN2017/108729, filed Oct. 31, 2017, the entire contents of both of which are incorporated herein by reference.

### TECHNICAL FIELD

The present disclosure relates to material detection and, more particularly, to a material detecting mechanism of a sowing machine, a sowing machine, and an unmanned aerial vehicle for protecting plants.

### BACKGROUND

When a sowing machine is operating, it is necessary to ensure that material is always present in the sowing machine to guarantee the continuity of the operation. In conventional technologies, most users rely on their vision to determine whether the material in the sowing machine is used up. This method not only causes inconvenience to the users, but also has poor timeliness.

### SUMMARY

In accordance with the disclosure, there is provided a sowing machine including a stirring mechanism and a material detecting mechanism. The stirring mechanism includes a rotating shaft. The material detecting mechanism includes a driven member, a magnetic member operably coupled to the driven member, and a Hall effect sensor. When the driven member is not blocked by material in the sowing machine, the driven member is configured to rotate under a driving force of the rotating shaft, and drive the magnetic member to rotate; and the Hall effect sensor is configured to detect a first signal corresponding to the magnetic member. When the driven member is blocked by the material in the sowing machine, the driven member is configured to stop rotating under a resistance of the material, and stop driving the magnetic member to rotate; and the Hall effect sensor is configured to detect a second signal corresponding to the magnetic member. The material detecting mechanism is further configured to determine whether the material exists in the sowing machine based on at least one of the first signal or the second signal.

### BRIEF DESCRIPTION OF THE DRAWINGS

In order to more clearly illustrate the technical solutions in embodiments of the present disclosure, drawings used in description of the embodiments will be briefly introduced below. Obviously, these drawings only illustrate some embodiments of the present disclosure. For those of ordinary skill in the art, other drawings can be obtained according to these drawings without inventive efforts.

FIG. 1 is a perspective view of a material detecting mechanism according to an example embodiment.

FIG. 2 is a perspective view of the material detecting mechanism from another viewing angle according to an example embodiment.

FIG. 3 is a schematic structural diagram of a portion of a material detecting mechanism according to an example embodiment.

FIG. 4 is a schematic structural diagram of an elastic piece cooperating with a groove in a material detecting mechanism according to an example embodiment.

FIG. 5 is a schematic structural diagram of the structure shown in FIG. 4 at another state (the elastic piece being separated from the groove).

FIG. 6 is a schematic diagram of detection results of a material detecting mechanism according to an example embodiment.

FIG. 7 is a schematic diagram of detection results of a material detecting mechanism according to another example embodiment.

FIG. 8 is a schematic diagram of detection results of a material detecting mechanism according to yet another example embodiment.

FIG. 9 is a schematic diagram of a material detecting mechanism according to another example embodiment.

FIG. 10 is a perspective view of an unmanned aerial vehicle for protecting plants according to an example embodiment.

Reference numbers used in the figures are as follows: rack 1; sowing machine 2; driven member 10; mounting part 11; elastic piece 12; magnetic member 20; first magnet 21; second magnet 22; Hall effect sensor 30; bearing 40; inner ring 41; outer ring 42; driven shaft 50; processor 60; alarm component 70; stirring mechanism 100; motor 110; rotating shaft 111; groove 111a; stirring member 120; material receiving case 200; material spreading mechanism 300; fixing frame 400; and material box 500.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

A material detecting mechanism of a sowing machine 2, the sowing machine 2 and an unmanned aerial vehicle (UAV) for protecting plants of the present disclosure will be described in detail below with reference to the drawings. The following embodiments and features/elements in those embodiments can be combined with each other when no conflict exists.

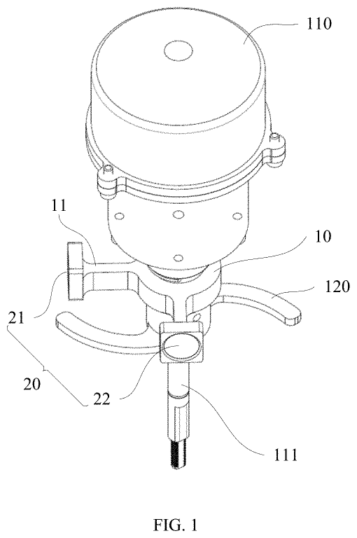

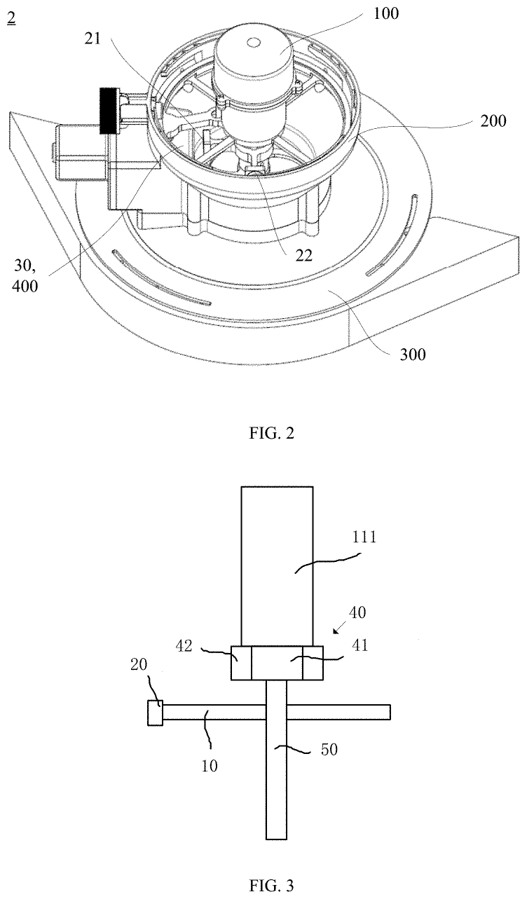

With reference to FIG. 1 and FIG. 2, the present disclosure provides a material detecting mechanism of a sowing machine 2, configured to cooperate with a stirring mechanism 100 of the sowing machine 2 and detect whether the stirring mechanism 100 currently has material to stir, thereby determining whether material exists in the sowing machine 2. Specifically, when the material detecting mechanism detects that there is material being stirred by the stirring mechanism 100, presence of material in the sowing machine 2 can be determined. When the material detecting mechanism detects that there is no material being stirred by the stirring mechanism 100, absence of material in the sowing machine 2 can be determined. The stirring mechanism 100 may include a rotating shaft 111 configured to drive a stirring member 120 of the sowing machine 2, so as to realize the stirring of the material. The rotating shaft 111 may be an output shaft of a power mechanism (for example, motor 110) of the stirring mechanism 100. Alternatively, the rotating shaft 111 may be coaxially fixedly connected with an output shaft of the power mechanism of the stirring mechanism 100.

With reference to FIGS. 1 and 2, the material detecting mechanism may include a driven member 10, a magnetic member 20, and a Hall effect sensor 30. The driven member 10 is configured to cooperate with the rotating shaft 111, the magnetic member 20 is configured to cooperate with the driven member 10, and the Hall effect sensor 30 is configured to cooperate with the magnetic member 20. The Hall effect sensor 30, also called Hall element, can detect a signal corresponding to the magnetic member 20. Specifically, when the driven member 10 is not blocked by material (i.e., there is no material being stirred by the stirring mechanism 100), the driven member 10 is rotated by the rotating shaft 111, thereby driving the magnetic member 20 to rotate. At this time, a signal detected by the Hall effect sensor 30 corresponding to the magnetic member 20 is referred as a first signal. When the driven member 10 is blocked by a material (i.e., there is material being stirred by the stirring mechanism 100), the driven member 10 stops rotating under the resistance of the material, and a signal detected by the Hall effect sensor 30 corresponding to the magnetic member 20 under this situation is referred as a second signal.

The first signal is different from the second signal so as to determine whether a material is present in the stirring mechanism 100. In some embodiments, through the cooperation of the driven member 10 and the rotating shaft 111, the driven member 10 can have relative motion against the rotating shaft 111 (e.g., when the rotating shaft 111 rotates, and the driven member 10 can either rotate or remain stationary), so that the magnetic member 20 can rotate at different speeds or stand still. The Hall effect sensor 30 is configured to detect different signals when the magnetic member 20 rotates at different speeds or stands still, so that a detection result of the Hall effect sensor 30 can be used to determine whether there is a material in the stirring mechanism 100. Further, whether material exists in the sowing machine 2 can be determined by determining whether material exists in the stirring mechanism 100.

It should be noted that, in embodiments of the present disclosure, a material may refer to one or more solid materials, such as seed, grain, pesticide, flour, sugar, salt, and/or fertilizers, or any other proper substance to be dispensed or spread by the sowing machine.

The magnetic member 20 may include two magnetic poles, the N pole (that is, the north pole) and the S pole (that is, the south pole). The magnetic member 20 can be directly or indirectly fixed to the driven member 10. Alternatively, the magnetic member 20 and the driven member 10 are non-fixedly connected, such as applying an abutment fit. The cooperating manner between the magnetic member 20 and the driven member 10 can be selected according to the specific structure of the magnetic member 20.

In some embodiments, as shown in FIG. 1 and FIG. 2, the driven member 10 may be provided with a mounting part 11. The mounting part 11 is configured to cooperate with or receive the magnetic member 20. For example, in one embodiment, the magnetic member 20 is fixedly connected to the mounting part 11. Optionally, a plug-in slot may be provided on the mounting part 11. One of the magnetic poles of a magnet of the magnetic member 20 (e.g., one end of a magnet) is configured to be inserted in the plug-in slot, and the other pole of the magnetic member 20 is configured to be detected by the Hall effect sensor 30. The Hall effect sensor 30 is configured to output different signals when sensing different magnetic fields (e.g., generated from the magnetic member 20 during its movement or staying still). In one embodiment, the mounting part 11 may be integrally formed with the driven member 10 to ensure the strength of the structure. Alternatively, the mounting part 11 can be assembled onto the driven member 10. In another embodiment, the magnetic member 20 and the driven member 10 are non-fixedly connected. For example, the magnetic member 20 can be abutted with the mounting part 11. When the driven member 10 is not blocked by the material, the driven member 10 rotates under the driving force of the rotating shaft 111, and the mounting part 11 rotates synchronously with the driven member 10. The mounting part 11 abuts the magnetic member 20, thereby driving the magnetic member 20 to rotate synchronously with the driven member 10. When the driven member 10 is blocked by the material, the mounting part 11 is deformed and separated from the magnetic member 20 under the resistance of the material, and the rotating shaft 111 drives the driven member 10 to idly rotate.

In some embodiments, the magnetic member 20 can be directly fixed on the driven member 10 without being connected through the mounting part 11. For example, the driven member 10 may include a receiving groove, and one of the magnetic poles of the magnetic member 20 may be fixed in the receiving groove, and the other magnetic pole may be cooperated with the Hall effect sensor 30 so as to detect the existence of the material.

The magnetic member 20 may include one or more magnets or other type of magnetic entity. In some embodiments, the magnetic member 20 may include a U-shaped magnet, or a magnet of another shape, such as a cuboid or a cylinder. In one embodiment, the magnetic member 20 include a U-shaped magnet. A middle part of the U-shaped magnet is directly fixed on the driven member 10. The two magnetic poles of the U-shaped magnet can cooperate with the Hall effect sensor 30. As the magnetic member 20 follows the driven member 10 to rotate, when the Hall effect sensor 30 is aligned with different magnetic poles of the U-shaped magnet, different voltage levels are detected, thereby generating a stable potential difference (i.e., the first signal). When the driven member 10 stops rotating, the magnetic member 20 also stops rotating, there is no change in the magnetic field, and the Hall effect sensor 30 does not output a potential difference. In this way, the existence of the material can be determined by analyzing the potential difference from the Hall effect sensor 30.

In another embodiment, the magnetic member 20 may include a magnet of an elongated shape, such as a cuboid or a cylinder. The number of magnets included in the magnetic member 20 can be selected according to practical situations. Optionally, the magnetic member 20 may include one magnet. One of the magnetic poles of the magnetic member 20 is operably coupled with the Hall effect sensor 30. Specifically, the Hall effect sensor 30 is configured to detect, when the magnetic member 20 rotates, a change in the magnetic field and output the first signal; and detect, when the magnetic member 20 stops rotating, no change of the magnetic field and output the second signal, thereby achieving the detection of whether the material exists. Optionally, the magnetic member 20 includes a first magnet 21 and a second magnet 22. The first magnet 21 and the second magnet 22 are distributed along the circumference or the rim of the driven member 10, and the polarity of one end of the first magnet 21 remote to the driven member 10 (i.e., a distal end, or an end of the magnet located further away from the driven member 10 among the two ends of the magnet) is opposite to the polarity of one end of the second magnet 22 remote to the driven member 10. The Hall effect sensor 30 is located near or at a same side as the ends of the first magnet 21 and the second magnet 22 further away from the driven member 10. The structural characteristics of the magnetic member 20 formed by the first magnet 21 and the second magnet 22 may be similar to a U-shaped magnet. The first magnet 21 and the second magnet 22 can be arranged at intervals, or can be arranged to contact each other. Alternatively, the ends of the first magnet 21 and the second magnet 22 further away from the driven member may have the same polarity, which is similar to the structure of one magnet. Optionally, the magnetic member 20 may include more than two magnets. The two or more magnets are distributed along the circumference or the rim of the driven member 10, and the Hall effect sensor 30 is located at a same side as the ends of the tow or more magnets distal from the driven member 10.

In some embodiments, the magnet(s) of the magnetic member 20 do not cover a full circle/rim of the driven member 10, so that the Hall effect sensor 30 can be aligned with one magnet of the magnetic member 20 intermittently, ensuring accurate detection of material existence. Any appropriate type of Hall effect sensor in existing technology can be used as the Hall effect sensor 30, which is not limited herein.

Relative rotation between the driven member 10 and the rotating shaft 111 can be achieved in different configurations. Some exemplary configurations are described in detail below.

Configuration I

With reference to FIG. 2 and FIG. 3, the material detecting mechanism may further include a bearing 40. The driven member 10 is connected to the rotating shaft 111 through the bearing 40. Through the transfer of the bearing 40, the driven member 10 can be rotated relative to the rotating shaft 111. Specifically, when the driven member 10 is not blocked by the material, the rotation of the rotating shaft 111 can drive the driven member 10 to rotate. When the driven member 10 is blocked by the material, the driven member 10 stops rotating, and the rotating shaft 111 becomes idling (i.e., idly rotating).

In one embodiment, an inner ring 41 of the bearing 40 is fixedly connected to the rotating shaft 111, and an outer ring 42 of the bearing 40 is fixedly connected to the driven member 10. When the rotating shaft 111 rotates and there is no material in the stirring mechanism 100, the bearing 40 has small resistance and facilitates the driven member 10 to rotate around the rotating shaft 111 at a stable speed, thereby driving the magnetic member 20 to rotate around the rotating shaft 111 at the stable speed. In this situation, a signal corresponding to the magnetic member 20 detected by the Hall effect sensor 30 is the first signal. When there is material in the stirring mechanism 100, the driven member 10 cannot rotate due to the resistance of the material. At this time, the rotating shaft 111 is idling, a signal corresponding to the magnetic member 20 detected by the Hall effect sensor 30 is the second signal.

The inner ring 41 of the bearing 40 is sleeved and fixed on an outer wall of the rotating shaft 111. Other proper fixing methods can be selected and used to fixedly connect the inner ring 41 of the bearing 40 to the rotating shaft 111 based on practical requirements.

Further, the driven member 10 may be sleeved and fixed on the outer ring 42 of the bearing 40. Other proper fixing methods can be selected and used to connect the driven member 10 with the outer ring 42 of the bearing 40, and is not limited herein.

In another embodiment, referring to FIG. 3, the material detecting mechanism may further include a driven shaft 50. The outer ring 42 of the bearing 40 is fixedly connected to the rotating shaft 111, the inner ring 41 of the bearing 40 is fixedly connected to the driven shaft 50, and the driven member 10 is fixed onto the driven shaft 50.

In this configuration, one side of the bearing 40 is fixedly connected to the rotating shaft 111, and the other side is fixedly connected to the driven shaft 50. Specifically, the outer ring 42 of the bearing 40 and the rotating shaft 111 may be fixedly connected by snapping, bonding, or other methods. The driven shaft 50 can be inserted into the inner ring 41 of the bearing 40 to achieve a fixed connection between the driven shaft 50 and the inner ring 41 of the bearing 40. The fixed connection between the driven shaft 50 and the inner ring 41 of the bearing 40 can also be achieved by other methods. The driven shaft 50 and the rotating shaft 111 of this configuration are arranged coaxially, which makes the structure more compact.

Configuration II

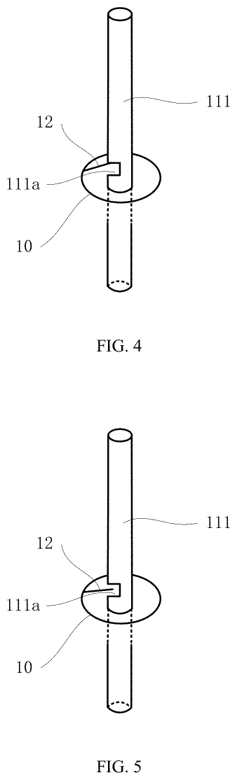

With reference to FIG. 4 and FIG. 5, the driven member 10 may be provided with an elastic piece 12, and a corresponding position of the rotating shaft 111 is provided with a groove 111a that cooperates/mates with the elastic piece 12. Specifically, referring to FIG. 4, when the driven member 10 is not blocked by the material, the elastic piece 12 abuts and mates with the groove 111a, and the driven member 10 is rotated by the rotating shaft 111, thereby driving the magnetic member 20 to rotate. Referring to FIG. 5, when the driven member 10 is blocked by some material, the elastic piece 12 is deformed and separated from the groove 111a under the resistance of the material, and the driven member 10 stops moving under the resistance of the material.

In this configuration, the driven member 10 is sleeved with the rotating shaft 111, the elastic piece 12 is disposed on an inner wall of the driven member 10, and the groove 111a is disposed at an outer wall of the rotating shaft 111. When the driven member 10 is not blocked by the material, the elastic piece 12 is mated with and/or fitted in the groove 111a, so that the rotating force of the rotating shaft 111 is transmitted to the driven member 10 through the elastic piece 12, and the driven member 10 is driven to rotate. When the driven member 10 is blocked by the material, the elastic piece 12 deforms under the pressure of the material and separates from the groove 111a. In this case, the rotating shaft 111 rotates, and the driven member 10 stops rotating. When the material is used up, the driven member 10 returns to a state where it is not blocked by the material, the elastic piece 12 elastically recovers, and is mated with the groove 111a again. The driven member 10 is driven by the rotating shaft 111 to rotate again, and the Hall effect sensor 30 can detect the first signal in time.

The elastic piece 12 can be made of elastic material such as plastic and/or silicone. Specifically, the material of the elastic piece 12 can be selected according to strength requirements for the elastic piece 12, so that when the driven member 10 is blocked by the material, the elastic piece 12 can be deformed to an extent of separating from the groove 111a, and when the driven member 10 is not blocked by the material, the elastic piece 12 can return to the state before being deformed and be mated with the groove 111a. In one embodiment, the elastic piece 12 can be integrally formed with the driven member 10, thereby improving the strength of the structure. In another embodiment, the elastic piece 12 may be a separate structure from the driven member 10, and the elastic piece 12 is fixedly connected to the inner side wall of the driven member 10.

Configuration III

The driven member 10 is fixedly connected to the rotating shaft 111, and the mounting part 11 is a flexible member. The flexible member is capable of being mated with the magnetic member 20 (e.g. in an abutted manner). In one embodiment, the flexible member and the magnetic member 20 are not fixedly connected. Specifically, when the driven member 10 is not blocked by the material, the driven member 10 rotates under the driving force of the rotating shaft 111, and the flexible member abuts the magnetic member 20, thereby pushing the magnetic member 20 to rotate. When the driven member 10 is blocked by the material, the flexible member deforms under the force of the material, causing the magnetic member 20 to be separated from the flexible member and stop rotating, while the rotating shaft 111 drives the driven member 10 to rotate in an idling state. When the material is used up, the driven member 10 returns to a state where it is not blocked by the material. The driven member 10 rotates under the driving force of the rotating shaft 111, and the flexible member elastically recovers and abuts with the magnetic member 20. The Hall effect sensor 30 can detect and generate the first signal in time. In one embodiment, the driven member 10 can be sleeved and fixed on the outer side wall of the rotating shaft 111. The cooperation of the flexible member and the magnetic member 20 can eliminate the arrangement of the bearing 40 and the driven shaft 50, and the structure is simpler and the cost is lower.

In addition, the flexible member can be made of elastic material such as plastic and silicone. Specifically, the material of the flexible member can be selected according to strength requirements of the flexible member, so that when the driven member 10 is blocked by the material, the flexible member can be deformed to an extent of separating from the magnetic member 20, and when the driven member 10 is not blocked by the material, the flexible member can restore to the state before being deformed and be abutted/mated with the magnetic member 20.

Further, the material detecting mechanism may further include a support frame configured to place the magnetic member 20. During the process that the driven member 10 drives the magnetic member 20 to rotate, the magnetic member 20 is always located on the support frame.

In some embodiments, when the Hall effect sensor 30 is aligned with the magnetic member 20, the Hall effect sensor 30 generates a pulse signal corresponding to the magnetic member 20, and a pulse duration (i.e., pulse width) of the signal indicates a duration of the magnetic member 20 being detected by the Hall effect sensor 30. In some other embodiments, the signal corresponding to the magnetic member 20 detected by the Hall effect sensor 30 may be an angular velocity at which the magnetic member 20 rotates. For example, the speed at which the magnetic member 20 rotates when the driven member 10 is not blocked by the material is faster than the speed at which the magnetic member 20 rotates when the driven member 10 is blocked by the material. The Hall effect sensor 30 is configured to detect a change in voltage levels (e.g., pulse amplitudes). Changing magnitudes among high and low levels is related to the rotating speed of the magnetic member 20, and the speed of the magnetic member 20 is related to the amount of material, and/or the speed of the rotating shaft 111.

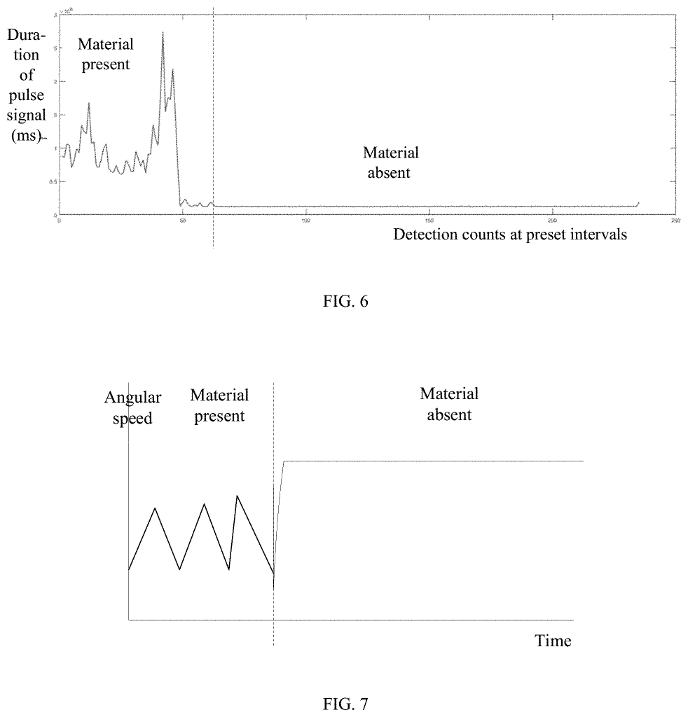

In some embodiments, the signal corresponding to the magnetic member 20 detected by the Hall effect sensor 30 (e.g., the first signal and/or the second signal) may be directly used to determine whether a material is present or absent in the stirring mechanism 100. For example, as shown in FIG. 6, the first signal and the second signal are durations of pulses detected by the Hall effect sensor 30. Since the speed of the magnetic member 20 when the driven member 10 is not blocked by the material is faster than the speed of the magnetic member 20 when the driven member 10 is blocked by the material, the durations of pulses detected by the Hall effect sensor 30 when the driven member 10 is not blocked by the material (that is, the first signal, the curve on the right side of the dotted line in FIG. 6) is relatively uniform. The durations of the pulses detected by the Hall effect sensor 30 when the driven member 10 is blocked by the material (that is, the second signal, the curve on the left side of the dotted line in FIG. 6) fluctuates a lot. For another example, referring to FIG. 7, the first signal and the second signal are angular speeds detected by the Hall effect sensor 30. In this case, since the speed of the magnetic member 20 is relatively uniform when the driven member 10 is not blocked by the material, and fluctuates when the driven member 10 is blocked by the material, the angular speed detected by the Hall effect sensor 30 when the driven member 10 is not blocked by the material (that is, the first signal, the curve to the right of the dotted line in FIG. 7) is generally uniform, and the angular speed detected by the Hall effect sensor 30 when the driven member 10 is blocked by the material (that is, the second signal, the curve to the left of the dotted line in FIG. 7) generally fluctuates according to varying amount of material.

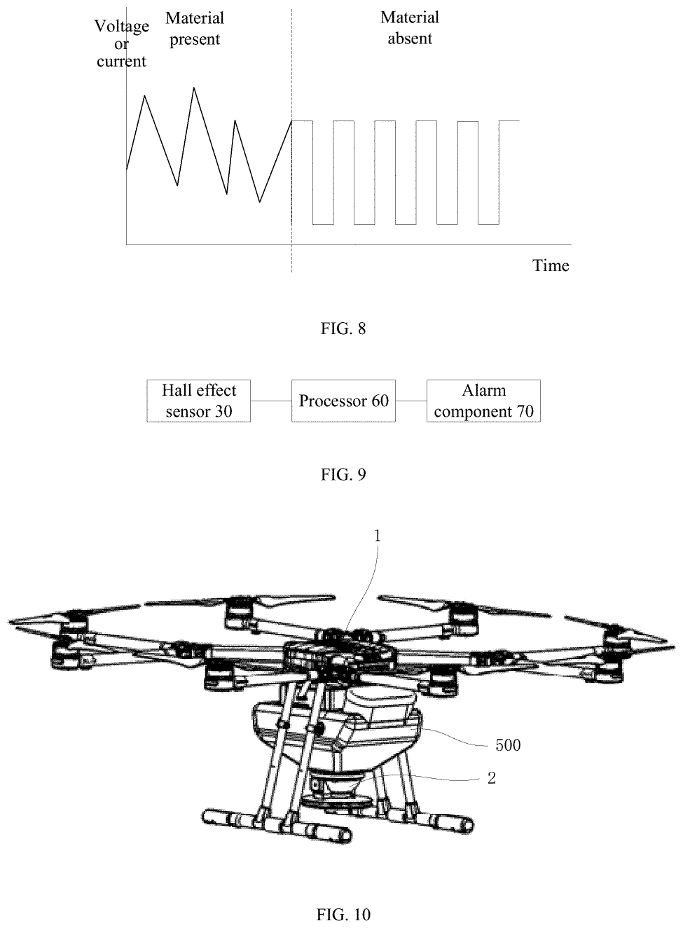

In some embodiments, the signals corresponding to the magnetic member 20 detected by the Hall effect sensor 30 can be processed (e.g., by a processor of the sowing machine 2 or an external processing device electrically connected to the Hall effect sensor 30), and the processed signal can be the first signal or the second signal, so as to determine whether a material exists in the stirring mechanism 100. For example, the signal detected by the Hall effect sensor 30 is processed into a voltage signal. That is, the first signal is a voltage signal corresponding to the signal of the magnetic member 20 detected by the Hall effect sensor 30 when the driven member 10 is not blocked by the material, and the second signal is a voltage signal corresponding to a signal of the magnetic member 20 detected by the Hall effect sensor 30 when the driven member 10 is blocked by the material. As shown in FIG. 8, the second signal (the curve to the right of the dotted line in FIG. 8) is a signal that changes periodically, and the first signal (the curve to the left of the dotted line in FIG. 8) is approximately unchanged. For another example, the signal of the magnetic member 20 detected by the Hall effect sensor 30 can be processed into a current signal, which is similar to processing the signal into the voltage signal. Also referring to FIG. 8, the second signal (the curve to the right of the dotted line in FIG. 8) is a signal that changes periodically, and the first signal (the curve to the left of the dotted line in FIG. 8) is approximately unchanged.

In some embodiments, the second signal may be a signal output by the Hall effect sensor 30 when the Hall effect sensor 30 is powered on and does not detect the magnetic member 20.

A detection result of the Hall effect sensor 30 can be displayed through the display component of the sowing machine 2 or an external display device (connected to the sowing machine 2), and the user can timely judge whether there is a material in the stirring mechanism 100 based on the detection result.

In some embodiments, referring to FIG. 9, the material detecting mechanism may further include a processor 60 and an alarm component 70. The Hall effect sensor 30 and the alarm component 70 are both electrically connected to the processor 60. Specifically, the processor 60 is configured to, in response to receiving the first signal sent by the Hall effect sensor 30, control the alarm component 70 to output an alarm signal, thereby reminding the user that there is no material in the sowing machine 2.

In some embodiments, the processor 60 may be any type of processor in the existing technology, such as a single-chip microcomputer, a programmable logic device, and the like. The alarm component 70 may include at least one of a light indicator or a sound module (e.g., a speaker), but is not limited thereto. For example, the alarm component 70 may also be a dialog window reminder. In one embodiment, the alarm component 70 includes an indicator light electrically connected to the processor 60. The alarm signal may be implemented by controlling at least one of a color, a duration, or a blinking state of the emitted indicator light. For example, when receiving the first signal sent by the Hall effect sensor 30, the processor 60 controls the indicator light to emit a red light with a blinking interval of 1 second. When receiving the second signal sent by the Hall effect sensor 30, the processor 60 controls the indicator light to emit other lights (different from the red light with a blinking interval of 1 s), or controls the indicator light to not emit or stop emitting light. In this way, a user can be notified about whether the material in the sowing machine 2 is currently present or not. In other embodiments, the alarm signal may also be implemented in other ways, and is not limited to the light emitting color, light emitting time, and blinking state of the indicator light. The location of the indicator light is not limited in the disclosed embodiments, and the indicator light may be provided on the material receiving case/shell of the sowing machine 2 or other parts of the sowing machine 2.

In another embodiment, the alarm component 70 includes a sound module. The sound module is electrically connected to the processor 60. The processor 60 is configured to, in response to receiving the first signal sent by the Hall effect sensor 30, control the sound module to generate an alarm sound, thereby reminding the user that there is no material in the sowing machine 2. When receiving the second signal sent by the Hall effect sensor 30, the processor 60 is configured to control the sound module to produce a sound different from the alarm sound, or control the sound module not to emit a sound, thereby implementing of a reminder about whether there is material in the sowing machine 2. The sound module may include a buzzer, a horn, a speaker, or other electronic devices capable of producing sound. In addition, the installation position of the sound module is not specifically limited in the embodiment of the present disclosure, and the sound module may be provided on the material receiving case of the sowing machine 2 or other parts of the sowing machine 2.

In another embodiment, the alarm component 70 includes a dialog window reminder. Optionally, the sowing machine 2 further includes a display screen, and the display screen is electrically connected to the processor 60. Alternatively, the processor 60 is communicatively connected to an external display device. The processor 60 is configured to, in response to receiving the first signal sent by the Hall effect sensor 30, control the display screen or the external display device to display a dialog window prompting a message such as “No material”. When receiving the second signal sent by the Hall effect sensor 30, the processor 60 is configured to control the display screen or the external display device to display a similar dialog window prompting a message such as “material exists”, or does not initiate display operation of the display screen or the external display device, that is, no dialog window is shown on the display or the external display device when the material is present.

The present disclosure also provides a sowing machine 2, which can be used alone or installed on machinery such as a plant protection UAV, an agricultural tractor, and the like, and can be used for sowing or seeding in agricultural production.

Referring to FIG. 2, the sowing machine 2 may include a stirring mechanism 100 and the aforementioned material detecting mechanism. The stirring mechanism 100 includes the rotating shaft 111, and the material detecting mechanism is configured to cooperate with the rotating shaft 111. For the specific structure of the material detecting mechanism, reference may be made to the description of the foregoing embodiments, and details are not described herein again.

In some embodiments, the stirring mechanism 100 includes a motor 110. The rotating shaft 111 is coaxially and fixedly connected to an output shaft of the motor 110, or the rotating shaft 111 is the output shaft of the motor 110. The motor 110 may be any type of motor in the existing technology, such as a brushless motor, a stepping motor, or an AC motor. Optionally, the brushless motor is used in one embodiment to accommodate requirements of field operations. In one embodiment, the motor 110 may be powered by an external power source, for example, connected to a power distribution box in a farm field through a connection line with a plug. Optionally, the sowing machine 2 further includes a battery electrically connected to the motor 110 and configured to supply power to the motor 110, so as to eliminate the need of using an electrical connection line to electrically connect the motor 110 to an external distribution box, improving the safety of the sowing machine 2, the appearance of the sowing machine 2 is beautiful and the structure is compact. In addition, a cover of the motor 110 may be provided outside the motor 110 to protect the motor 110.

In one embodiment, the stirring mechanism 100 may further include a stirring member 120. The stirring member 120 is disposed on the rotating shaft 111 and configured to stir the material. With reference to FIG. 1 and FIG. 2, in one embodiment, the stirring member 120 includes one or more stirring rods, and the one or more stirring rods can be fixed on the rotating shaft 111. A stirring rod may be a straight rod, an arc-shaped rod, and/or other special-shaped rod to achieve different stirring requirements. In addition, the stirring rod(s) may be directly fixed on the rotating shaft 111; or one end of at least one stirring rod (for example, two arc-shaped rods shown in FIGS. 1 and 2) may be fixed on a collar ring. The collar ring is fixedly sleeved on the rotating shaft 111, so as to achieve the purpose of fixing the stirring rod on the rotating shaft 111.

In one embodiment, as shown in FIG. 10, the sowing machine 2 may further include a material box 500 with a material inlet (not shown) on top and a material outlet at the bottom (not shown). The stirring mechanism 100 is disposed at the material outlet to make the stirring more effective by a rotating manner. Specifically, the material box 500 may include any type of box body having a storage function in the existing technology, and the specific shape and volume of the box body are not limited herein. In some embodiments, the material box 500 may be provided separately or shared with other devices. For example, when the sowing machine 2 is installed on a plant protection UAV, a water tank of the plant protection UAV may be used as the material box 500, or a material box 500 of the sowing machine 2 is separately provided on the plant protection UAV. By setting the material box 500, there is no need to supply the material manually during the whole sowing process, ensuring a more convenient process.

The sowing machine 2 may further include a material receiving case 200, which may be disposed at the bottom of the material box 500 (i.e., on the same end of the material outlet), so as to guide the material flowing out of the material outlet and into the material receiving case 200. In some embodiments, the material receiving case 200 may be detachably or non-detachably connected to the bottom of the material box 500. For example, the material receiving case 200 and the material box 500 may be detachably connected through a rotary bayonet fitting or thread fitting. In one embodiment, a slot (for example, an approximately L-shaped slot) may be provided in the material receiving case 200, and a corresponding protrusion (such as a protrusion with a rectangle cross section or a circle cross section) is provided at the bottom of the material box 500 configured to mate with the slot, so as to achieve the detachable connection between the material receiving case 200 and the material box 500. In another embodiment, the material receiving case 200 and the material box 500 can be detachably connected by a threaded structure. In some embodiments, the rotating shaft 111 is accommodated in the material receiving case 200 so as to serve as a power output of the stirring mechanism 100 to stir the material in the material receiving case 200, preventing clogging of the material.

The sowing machine 2 may further include a fixing frame 400 provided on an inner side wall of the material receiving case 200, and the Hall effect sensor 30 can be disposed on the fixing frame 400. Optionally, the Hall effect sensor 30 may be housed inside the fixing frame 400 to protect the Hall effect sensor 30. Alternatively, the Hall effect sensor 30 may be provided outside the fixing frame 400. In addition, the Hall effect sensor 30 may be directly or indirectly fixed on the fixing frame 400. For example, a slot is provided on the fixing frame 400, and the Hall effect sensor 30 can be inserted in the slot for fixation.

The sowing machine 2 may further include a material spreading mechanism 300, and the material spreading mechanism 300 is disposed at the bottom of the material receiving case 200. The material spreading mechanism 300 may be connected to the bottom of the material receiving case 200 in a detachable or non-detachable connection manner. The detachable or non-detachable connection manner may adopt any connection manner in the existing technology, which is not limited herein. In addition, the material spreading mechanism 300 may be any device in the existing technology that can implement the material spreading or distribution function on the sowing machine 2, such as a turntable or other structure.

During operation, the material in the material box 500 are controlled to enter into the material receiving case 200 through the material outlet, and the stirring mechanism 100 and the material detecting mechanism are started. The rotating shaft 111 of the stirring mechanism 100 is controlled to rotate, so as to stir the material in the material receiving case 200 and speed up the material to move from the material receiving case 200 into the material spreading mechanism 300, and finally the material spreading mechanism 300 is configured to spread the material to a work area. The material detecting mechanism in the material receiving case 200 is configured to detect whether there is a material in the material receiving case 200 and can promptly inform the user whether the material is used up. Specifically, when there are material in the material box 500, the material continuously fall into the material receiving case 200 from the material outlet, and the Hall effect sensor 30 of the material detecting mechanism outputs a first signal. When the material in the material box 500 is used up, no material falls into the material receiving case 200, and the Hall effect sensor 30 of the material detecting mechanism outputs a second signal. The user can timely monitor the presence or absence of the material by identifying the signal output by the Hall effect sensor 30.

During a sowing process, stirring speed, spreading speed, and material output volume can be adjusted according to various factors such as particle size of the material, sowing amount per unit area, and the area of operation, etc. For example, these adjustments can be made according to instructions from a remote control, and/or application software at a smart terminal or computer.

The present disclosure also provides a UAV for sowing in agricultural production. The UAV may be referred as a plant protection UAV or a UAV for protecting plants.

Referring to FIG. 10, the plant protection UAV may include a rack 1 and the sowing machine 2 described above. The rack 1 may be any type of rack used in existing UAVs, for example, a rack of an existing four-rotor UAV, or a rack of an existing six-rotor UAV. Reference can be made to the foregoing embodiments about the structure, function, working principle, and effect of the sowing machine 2, and details are not described herein again. In addition, the sowing machine 2 can be detachably or non-detachably installed below the rack 1 of the plant protection UAV. For example, the sowing machine 2 is disposed below a propulsion component on the rack 1. In some embodiments, the sowing machine 2 and the rack 1 of the plant protection UAV can be detachably connected together through quick-release parts, and the quick-release parts can adopt any quick-release parts in the existing technology, such as quick-release boards, Snap-on structures or threads.

In some embodiments, a water tank of the plant protection UAV may be used as a material box 500 of the sowing machine 2 or a material box 500 may be separately provided. When the material box 500 of the sowing machine 2 is separately provided, the material box 500 may be fixed on a leg frame or bottom frame of the plant protection UAV. Optionally, a frame connection member is provided on the material box 500 for fixing the material box 500 to the plant protection UAV. The frame fixing member may be any form of fixing member in the existing technology, such as a bolt connection or a Snap-On connection.

In some embodiments, a radar can be provided on the sowing machine 2 to avoid obstacles, thereby improving the obstacle avoidance capability of the plant protection UAV and avoiding collisions between the plant protection UAV and obstacles during flight.

In some embodiment, the flight controller of the plant protection UAV is electrically connected to the motor 110 of the stirring mechanism 100 through an electronic speed control (ESC) configured to control an operation state of the motor 110. The electrical connection between the motor 110 of the stirring mechanism 100 and the flight controller can be wired or wireless, achieving transmission of control signals. The flight controller and the ESC may be any type of flight controller and ESC used in the existing technologies related to plant protection UAVs or other types of UAVs.

Before operation of the plant protection UAV, material is loaded into the material box 500 or into a water tank of the UAV which functions as the material box 500, and then the plant protection UAV is started. When the plant protection UAV reaches the working area, the material in the material box 500 is controlled to fall into the material receiving case 200, the stirring mechanism 100 is started. The rotating shaft 111 of the stirring mechanism 100 is controlled to rotate, and the material detecting mechanism detects whether there is any material falling into the material receiving case 200, which is convenient for users to monitor presence and absence of material during operation of the plant protection UAV. Specifically, when there is material in the material box 500, the material can continuously fall into the material receiving case 200 from the material outlet, and the Hall effect sensor 30 of the material detecting mechanism outputs the first signal. When the material in the material box 500 is used up, no material falls into the material receiving case 200, and the Hall effect sensor 30 of the material detecting mechanism outputs the second signal. The user can timely monitor the presence or absence of the material by identifying the signal output by the Hall effect sensor 30.

In an exemplary embodiment, through the cooperation of the driven member 10, the magnetic member 20, and the Hall effect sensor 30, a determination on whether the stirring mechanism 100 of the sowing machine 2 is stirring material or doing idling rotation can be timely made, thereby timely determining whether material is present in the sowing machine 2. The material detecting mechanism has simple structure, and the automatic detection of the existence of the material by the material detecting mechanism also brings great convenience to the user.

It should also be noted that in the present disclosure, relational terms such as first and second, etc., are only used to distinguish one entity or operation from another entity or operation, but do not necessarily require and imply that there is any such actual relationship or sequence between these entities or operations. Moreover, terms “include”, “including” or any other variations thereof are intended to cover non-exclusive inclusions such that a process, a method, an article, or a terminal device that includes a series of elements includes not only those elements but also includes unspecified elements or elements inherent in such process, method, article or terminal device. In the case of no more limitation, an element defined by a sentence “include one . . . ” does not exclude that there is another same element in the process, the method, the article, or the terminal device that includes the element.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A sowing machine comprising:
a stirring mechanism comprising a rotating shaft; and
a material detecting mechanism, comprising:
a driven member;
a magnetic member operably coupled to the driven member; and
a Hall effect sensor,
wherein:
when the driven member is not blocked by material in the sowing machine, the driven member is configured to rotate under a driving force of the rotating shaft, and drive the magnetic member to rotate; and the Hall effect sensor is configured to detect a first signal corresponding to the magnetic member;
when the driven member is blocked by the material in the sowing machine, the driven member is configured to stop rotating under a resistance of the material, and stop driving the magnetic member to rotate; and the Hall effect sensor is configured to detect a second signal corresponding to the magnetic member; and
the material detecting mechanism is further configured to determine whether the material exists in the sowing machine based on at least one of the first signal or the second signal.

2. The sowing machine of claim 1, wherein the material detecting mechanism further comprises a bearing configured to connect the driven member with the rotating shaft.

3. The sowing machine of claim 2, wherein:
an inner ring of the bearing is fixedly connected to the rotating shaft; and
an outer ring of the bearing is fixedly connected to the driven member.

4. The sowing machine of claim 2, wherein the material detecting mechanism further comprises a driven shaft, wherein:
an inner ring of the bearing is fixedly connected to the rotating shaft;
an outer ring of the bearing is fixedly connected to the driven shaft; and
the driven member is fixedly connected to the driven shaft.

5. The sowing machine of claim 1, wherein:
an elastic piece is disposed on the driven member;
the rotating shaft is provided with a groove at a location corresponding to the elastic piece;
when the driven member is not blocked by the material, the elastic piece and the groove are connected in an abutting manner; and
when the driven member is blocked by the material, the elastic piece is configured to deform under a force of the material and separate from the groove.

6. The sowing machine of claim 1, wherein:
the driven member is provided with a mounting part; and
the mounting part is configured to be mated with the magnetic member.

7. The sowing machine of claim 6, wherein:
the mounting part is a flexible member configured to be mated with the magnetic member in an abutting manner;
when the driven member is not blocked by the material, the flexible member abuts; and
when the driven member is blocked by the material, the elastic piece is configured to deform under a force of the material and separate from the groove.

8. The sowing machine of claim 7, wherein the material detecting mechanism further comprises:
a support frame configured to house the magnetic member, wherein during a process that the driven member drives the magnetic member to rotate, the magnetic member is always located on the support frame.

9. The sowing machine of claim 6, wherein the magnetic member is fixedly connected to the mounting part.

10. The sowing machine of claim 9, wherein the mounting part is provided with a plug-in slot configured to receive one end of a magnet of the magnetic member.

11. The sowing machine of claim 1, wherein the magnetic member is a U-shaped magnet, and both poles of the U-shaped magnet are detectable by the Hall effect sensor.

12. The sowing machine of claim 1, wherein the magnetic member comprises a first magnet and a second magnet, wherein:
the first magnet and the second magnet are distributed along a circumference of the driven member;
a polarity of one end of the first magnet distal from the driven member is opposite to a polarity of one end of the second magnet distal from the driven member; and
the Hall effect sensor is located at a same side of the ends of the first and second magnets distal from the driven member.

13. The sowing machine of claim 1, wherein the material detecting mechanism further comprises a processor and an alarm component, the Hall effect sensor and the alarm component being respectively connected to the processor; and
the processor is configured to receive the first signal from the Hall effect sensor, and in response to the first signal, control the alarm component to output an alarm signal.

14. The sowing machine of claim 13, wherein the alarm component includes at least one of an indicator light or a sound producing module.

15. The sowing machine of claim 1, wherein:
the first signal and the second signal are durations of pulse signals detected by the Hall effect sensor; or
the first signal and the second signal are angular speeds detected by the Hall effect sensor.

16. The sowing machine of claim 1, wherein: the first signal and the second signal are obtained by processing signals of the magnetic member detected by the Hall effect sensor.

17. The sowing machine of claim 16, wherein:
the first signal and the second signal are voltage signals corresponding to the signals of the magnetic member detected by the Hall effect sensor; or
the first signal and the second signal are current signals corresponding to the signals of the magnetic member detected by the Hall effect sensor.

18. The sowing machine of claim 1, wherein:
the stirring mechanism further comprises a motor; and
the rotating shaft is coaxially fixedly connected with an output shaft of the motor.

19. The sowing machine of claim 1, wherein:
the stirring mechanism further comprises a stirring member disposed on the rotating shaft.

20. The sowing machine of claim 1, further comprising:
a material box;
wherein: a material inlet is provided on top of the material box and a material outlet is provided on bottom of the material box; and
the stirring mechanism is disposed at the material outlet.
